(19) United States
(12) Patent Application Publication
(10) Pub. No.: US 2009/0119295 A1
(43) Pub. Date: May 7, 2009

(54) ELECTRONIC DEVICE WITH A COPY CONTROLLING FUNCTION AND METHOD OF COPY CONTROLLING

(75) Inventors: Cheng-Hao Chou, Tu-Cheng (TW); Te-Yuan Kung, Tu-Cheng (TW); Chung-Jen Lan, Tu-Cheng (TW); Xiao-Guang Li, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/189,811

(22) Filed: Aug. 12, 2008

(30) Foreign Application Priority Data
Nov. 2, 2007 (CN) 200710124251.0

(51) Int. Cl. G06F 7/08; G06F 12/00; G06F 17/30

(52) U.S. Cl. 707/7; 707/200; 707/204; 707/E17.005

(57) ABSTRACT

A copy controlling method includes supplying at least two slots for receiving storage devices; determining a first storage device and a second storage device when the two slots are connected with storage devices; determining the free space remaining on the second storage device and if the second storage can accept all files to be copied from the source storage device; copying files from the first storage device to the second storage device, therein the size of the files to be copied is determined based on the free space of the second storage device. An electronic device with a copy controlling function is also provided.

### BACKGROUND

1. Technical Field

The present invention relates to an electronic device with a copy controlling function that can control file copying between different storage devices.

2. General Background

With the rapid development of electronic devices, it is easy to share information among different electronic devices. The common method is to connect one electronic device to another, backing up the files needed in the computer, then connecting another electronic device to the computer, and copying the backed-up files in the computer to the other electronic device.

Because computers are typically not handy at all times, it is inconvenient to solely depend on them for exchanging files between electronic devices.

What is needed, therefore, is an electronic device with a copy controlling function that can control file copying between different storage devices conveniently.

### SUMMARY

A copy controlling method includes supplying at least two slots for receiving storage devices; determining a first storage device and a second storage device when the two slots are connected with storage devices; determining the free space remaining on the second storage device and if the second storage can accept all files to be copied from the source storage device; copying files from the first storage device to the second storage device, therein the size of the files to be copied is determined based on the free space of the second storage device.

Other advantages and novel features will be drawn from the following detailed description of exemplary embodiments of the present invention with reference to the accompanying drawings.

### BRIEF DESCRIPTION OF THE DRAWINGS

The components of the drawings are not necessarily drawn to scale, the emphasis instead being placed upon clearly illustrating the principles of the electronic device with a copy controlling function that can control file copying between different storage devices. Moreover, in the drawings, like reference numerals designate corresponding parts throughout the several views.

FIG. 1 is an exemplary block diagram for a hardware infrastructure of an electronic device with a copy controlling function in accordance with an exemplary embodiment of the invention.

FIG. 2a and FIG. 2b are flowcharts depicting file copying between different storage devices implemented by the electronic device of FIG. 1 in accordance with an exemplary embodiment of the invention.

### DETAILED DESCRIPTION OF THE EMBODIMENTS

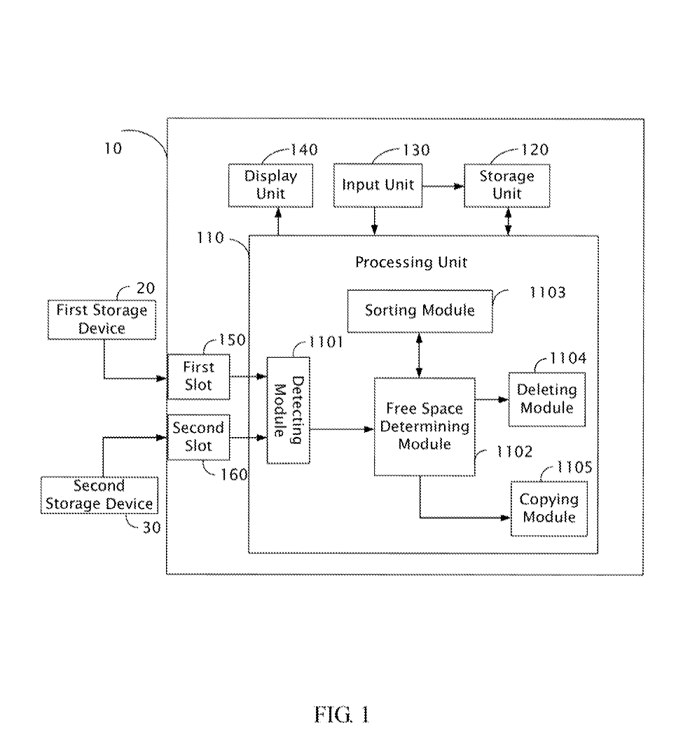

FIG. 1 is an exemplary block diagram of a hardware infrastructure of an electronic device with a copy controlling function. The electronic device 10 includes a processing unit 110, a storage unit 120, an input unit 130, a display unit 140, and at least two slots for connecting with storage devices. For example, in the embodiment as shown in FIG. 1, a first slot 150 is connected to a first storage device 20, and a second slot 160 is connected to a second storage device 30. The first storage device 20 and the second storage device 30 can be, but are not limited to, SD cards, MD cards, MP3 players, and digital cameras.

The storage unit 120 stores a table. The table is configured for recording a plurality of file sorting criteria. The file sorting criteria include, but are not limited to, file size, creation time, browse time, last browse time. The processing unit 110 sort files in the first storage device 20 and the second storage device 30 according to the file sorting criteria. The input unit 105 is used for receiving a user's input. The file sorting criteria can be selected by a user via the input unit 130, or be preset as a system default setting.

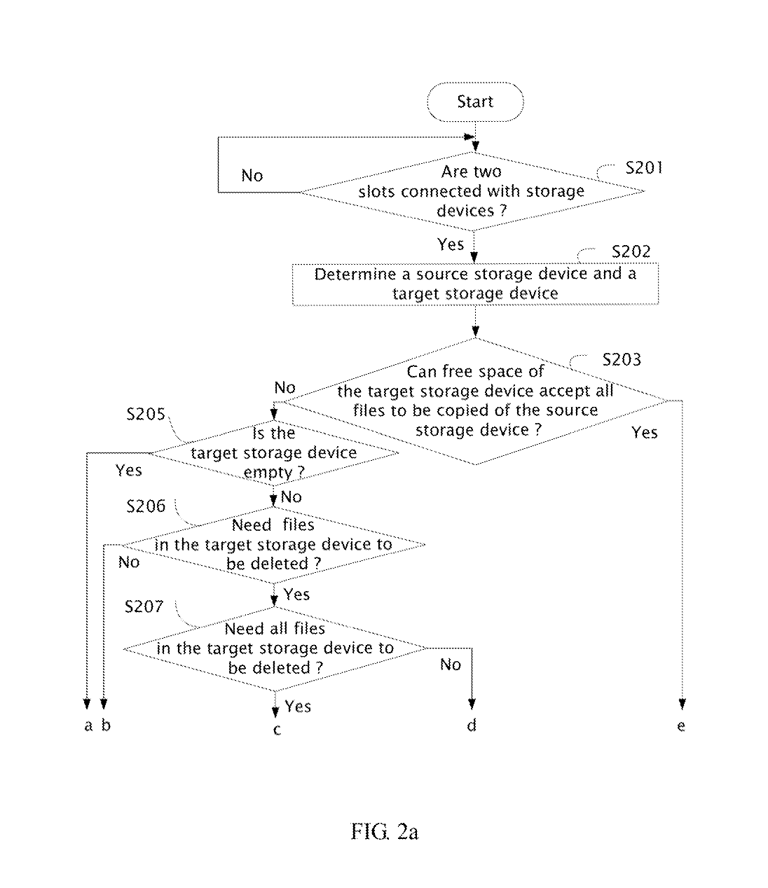

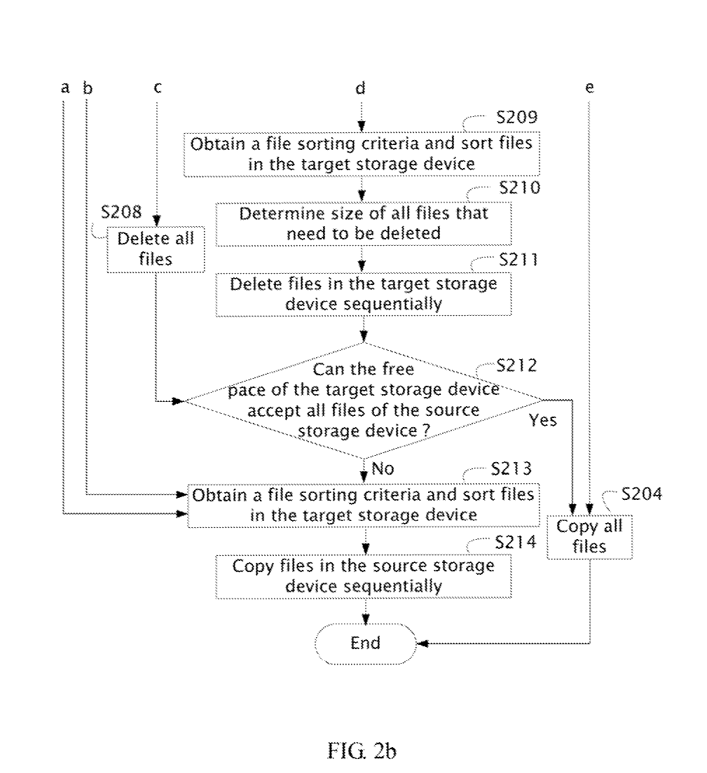

The processing unit 110 includes a detecting module 1101, a free space determining module 1102, a sorting module 1103, a deleting module 1104, and a copying module 1105. The functions of the modules in the processing unit 110 are described below together with FIG. 2.

FIG. 2a and FIG. 2b are flowcharts depicting file copying between different storage devices implemented by the electronic device of FIG. 1.

In step 201, the detecting module 1101 detects whether the first slot 150 and the second slot 150 are connected with the first storage device 20 and the second storage device 30.

If the first slot 150 and the second slot 150 are connected with the first storage device 20 and the second storage device 30, in step 202, the detecting module 1101 determines a source storage device and a target storage device between the first storage device 20 and the second storage device 30. The source storage device supplies files to be copied, and the target storage device supplies room to receive files copied from the source storage device. The designation of the source storage device and the target storage device can be preset or be selected by the user via the input unit 130. For example, the first slot 150 can be preset to be connected with the source storage device, and the second slot 160 can be preset to be connected with the target storage device. As such, the first storage device 20 is the source storage device, and the second storage device 30 is the target storage device.

In step 203, the free space determining module 1102 determines whether the target storage device (i.e., the second storage device 30) has free space to accept files to be copied from the source storage device (i.e., the first storage device 20).

In step 204, if the second storage device 30 has the free space to accept the files from the first storage device 20, the copying module 1105 copies the files from the first storage device 20 to the second storage device 30.

In step 205, if the second storage device 30 does not have enough free space to accept the files from the first storage device 20, the free space determining module 1102 determines whether the second storage device 30 is empty. If the second storage device 30 is empty, step 213 is executed.

If the second storage device 30 is not empty, in step 206, the deleting module 1104 prompts a user whether to delete files in the second storage device 30 to make more space. If the user does not want to delete files in the second storage device 30, step 213 is executed.

If the user wants to delete files in the second storage device 30, in step 207, the deleting module 1104 prompts the user whether to delete all the files in the second storage device 30.

If the user needs to delete all files in the second storage device 30, in step 208, the deleting module 1104 deletes all the files in the second storage device 30.

If the user does not need to delete all files in the second storage device 30, in step 209, the sorting module 1103 obtains a file sorting criteria, and sorts files in the second storage device 30 according to the file sorting criteria, and thereby creates a deleting sorting list. Take one file sorting criteria of last browse time for an example, all files in the second storage device 30 will be sorted according to its last browse time, the top on the deleting sorting list is the file nearest browsed. The toper on the deleting sorting list, the file is neared browsed.

In step 210, the deleting module 1104 determines a size of the files that needs to be deleted (the size). Decision can be made based on the user's input, the free space of the second storage device 30 and/or the size of files to be copied in the first storage device 20. That is, the user can decide and input the size, or the deleting module 1104 automatically calculates the size based on predetermined algorithms, e.g. by subtracting the free space of the second storage device 30 from a size of the files from the first storage device 20 to determine the size of files to be deleted on the second storage device 30.

In step 211, the deleting module 1104 deletes files in the second storage device 30 according to the determined size sequentially. That is, the file on the top of the deleting sorting list is first deleted, and then the deleting module 1104 deletes files as it can based on the determined size and the deleting sorting list.

In step 212, the free space determining module 1102 determines whether the free pace of the second storage device 30 can accept the files from the first storage device 20. If the free space of the second storage device 30 can accept the files from the first storage device 20, step 204 is executed.

If the free space of the second storage device 30 cannot accept the files from the first storage device 20, in step 213, the sorting module 1103 obtains the file sorting criteria, and sorts files in the first storage device 20 according to the file sorting criteria, and creates a copy sorting list.

In step 214, the copying module 1105 copies files from the sorted files in the first storage device 20 to the second storage device 30 sequentially. That is, the file on the top of the copy sorting list is first copied, and then the copying module 1105 copies as much files as it can sequentially based on the copy sorting list.

In a second embodiment, the deleting operation further moves files that need to be deleted from the second storage device 30 to the storage unit 120 in the electronic device 10 or other external storage devices.

Although the present invention has been specifically described on the basis of exemplary embodiments thereof, the invention is not to be construed as being limited thereto. Various changes or modifications may be made to the embodiment without departing from the scope and spirit of the invention.

What is claimed is:

1. An electronic device with a copy controlling function, comprising:
at least two slots capable of receiving storage devices;
a detecting module capable of determining a first storage device and a second storage device when the two slots are connected with storage devices;
a free space determining module capable of determining the free space remaining on the second storage device and if the second storage can accept all files from a first storage device; and
a copying module capable of copying files from a first storage device to the second storage device, wherein the size of files to be copied is determined based on the free space of the second storage device.

2. The electronic device according to claim 1, further comprising a sorting module capable of sorting files in a first storage device when the free space of a second storage device cannot accept files to be copied in the first storage device, and creating a copy sorting list; and the copying module further capable of copying the files in the first storage device to the second storage device sequentially based on the copy sorting list.

3. The electronic device according to claim 2, further comprising a storage unit capable of storing a table, wherein the table records at least one file sorting criteria, and the sorting module sorts the files in the source storage device according to the at least one file sorting criteria.

4. The electronic device according to claim 1, further comprising a deleting module capable of determining a size of files that need to be deleted, and deleting files according to the determined size when the free space of a second storage device cannot accept all files to be copied.

5. The electronic device according to claim 4, further comprising a sorting module capable of sorting files in a second storage device when the free space of the second storage device cannot accept all files to be copied in a first storage device, and creating a deleting sorting list; and the deleting module is further capable of deleting files in the second storage device sequentially based on the deleting sorting list and the determined size.

6. The electronic device according to claim 4, wherein the deleting module is further capable of moving files that need to be deleted from the second storage device to the storage unit in the electronic device or other external storage devices.

7. A copy controlling method comprising:
supplying at least two slots for receiving storage devices;
determining a first storage device and a second storage device when the two slots are connected with storage devices;
determining the free space remaining on the second storage device and if the second storage can accept all files to be copied from the source storage device;
copying files from the first storage device to the second storage device, wherein the size of the files to be copied is determined based on the free space of the second storage device.

8. The method according to claim 7, further comprising sorting files in the first storage device when the free space of the second storage device cannot accept all files to be copied in the first storage device, and creates a copy sorting list; and wherein the copying step copies the files in the first storage device to the second storage device sequentially based on the copy sorting list.

9. The method according to claim 8, further comprising supplying a table, wherein the table records at least one file sorting criteria, and the sorting step sorts the files in the first storage device according to the at least one file sorting criteria.

10. The method according to claim 7, further comprising determining a size of files that need to be deleted and deleting files according to the determined size when the free space of the second storage device cannot accept all files to be copied from the first storage device.

11. The method according to claim 10, further comprising sorting files in the second storage device when the free space of the second storage device cannot accept all files to be copied in the first storage device, and creating a deleting sorting list; and wherein the deleting step deletes files in the target storage device sequentially based on the deleting sorting list and the determined size.

12. The method according to claim 10, further comprising, moving files that need to be deleted from the second storage device to the storage unit in the electronic device or other external storage devices.
